(19) United States
(12) Patent Application Publication
(10) Pub. No.: US 2013/0164551 A1
(43) Pub. Date: Jun. 27, 2013

(54) CLEAR TRANSPARENT ANTI-FOG MULTI-LAYER FILM

(71) Applicant: Helwig Heinrich Daum, Willingshausen (DE)

(72) Inventor: Helwig Heinrich Daum, Willingshausen (DE)

(73) Assignee: KOBUSCH-SENGEWALD GMBH, Warburg (DE)

(21) Appl. No.: 13/808,005

(22) PCT Filed: Apr. 11, 2011
(86) PCT No.: PCT/DE2011/075071

§ 371 Date: Mar. 15, 2013

(30) Foreign Application Priority Data
Jul. 2, 2010 (DE) 20 2010 007 972.1

(51) Int. Cl. B32B 27/08

(52) U.S. Cl. CPC B32B 27/08
USPC 428/519

(57) ABSTRACT

A clear, transparent anti-fog multi-layer film with improved resistance to delamination and desirable functional endurance, which includes at least one sealing layer that contains an anti-fog additive made of a polyolefin/anti-fog agent mixture, at least one anti-fog agent barrier layer containing 80-100% propylene, and at least one outer layer.

The invention relates to a polyolefin multi-layer film, which comprises at least one anti-fog sealing layer, a cover layer with a higher sealing temperature, and gas and/or moisture barrier layers, where necessary.

Polyolefin multi-layer film shall be understood in this application to mean products containing more than 25% polypropylene with reference to the complete film or every layer of the film, respectively. Polypropylene has the properties of a high melting point and therefore excellent sterilizability, excellent availability, and excellent mechanical properties with regards to stability, rigidity, tensile strength and scratch resistance.

Multi-layer film of this type has application in the packaging of hydrous materials, such as foodstuffs, in which condensation can form in storage. In these situations, multi-layer film is used as an inspection window or alternatively as a pouch, which should be as clear and transparent as possible to allow for inspection of the contents of the package for possible decomposition or mould formation or alternately for size and texture of the contents. The release of water from goods that are so packaged leads to the accumulation of condensation on the packaging, especially on the cover film, or to water droplets which can restrict or prevent viewing of the product. Water droplets which form in this way are referred to as “fog”, and the material which prevents these water droplets is known as “anti-fog agent” or “anti-fog additive”. In film that lacks anti-fog properties or has insufficient anti-fog properties, the moisture in the packaged foodstuff leads to the formation of water droplets on the film surface through condensation. These droplets interfere with the transparency and shelf life of the packaged goods. The droplets do not adhere to the film cover indefinitely, and the moisture which drips down causes an acceleration of decay and mould formation on the foodstuffs. In addition, the droplets on the film surface act as a focal lens for light that enters the package. Films that have anti-fog properties prevent the damaging effects of droplet-shaped vapour and water condensation.

Anti-fog properties of films can be achieved by coating with anti-fog solution or by mixing anti-fog additive in the product side film layers. Anti-fog additives of this type are generally bivalent compounds that have a nonpolar aliphatic area that anchors in the polyolefin matrix and a polar hydrophilic area that can interact with water and reduce the surface tension of the water droplets to form a transparent film of water on the film. This polar area ensures the incompatibility of anti-fog additives with pure polyolefins such as polyethylene, which leads to the migration of the additive into the film surface. The polar area of the anti-fog agent is then directed outward and can interact with water. The anti-fog additive lowers the contact angle of the water droplets and allows the formation of a continuous transparent film of water on the film surface. Anti-fog additives are therefore surface-active additives, which are ideally used as a combination of different substance classes. Suitable substances which are combined with each other for use as anti-fog additives, are described in e.g. WO 97/22655A1, which is hereby expressly referred to in order to avoid repetition. Components of an anti-fog agent combination e.g., esters of fatty acids and their derivatives, aliphatic alcohols and their esters, multi-ethoxylated aromatic alcohols, mono- or multi-esterified sorbitol esters, mono or multi-esterified glycerol esters, blended glycerol esters, ethoxylated sorbitan esters, and ethoxylated amines. The above-named esters are mostly caused by an esterification of the associated acid with medium- or long-chain fatty acids.

Active agent combinations are typically from one of three substance classes: glycerol esters, sorbitol esters, and ethoxylated amines.

In order to achieve anti-fog properties, the sealing layer can be a composite-layer film coated with an appropriate anti-fog coating. A layer coated with an anti-fog lacquer only has a short lifespan, because it dissolves immediately in water. The active ingredient (esterified surfactants) is quickly depleted, and the number of cycles is limited.

The anti-fog additive can be incorporated directly or through a concentrate, a so-called “masterbatch”, into the polymer layers of the film itself. Masterbatches are polyolefin/anti-fog agent mixtures which contain the anti-fog additive in a high concentration compared to the film layer, generally 10-50% by weight but preferably 15-40% by weight of the additive with reference to the total weight of the masterbatch. The polyolefins in the masterbatch are generally common polyolefins, such as polyethylene or polypropylene. Anti-fog additives and corresponding masterbatches are well-known and commercially available.

One of the additives mixed into the sealing layer migrates out of the sealing layer toward the product but also toward the cover layer, whereby the overall characteristics of the multi-layer film deteriorate, Batch systems in multi-layer films that have adhesion promoters and EVOH-film layers (a common oxygen barrier layer) exhibit a migration of the anti-fog substance even in the direction of the polar (EVOH) material, making them opaque and lose their adhesive properties on the other layers of the multi-layer film. This leads to reduced anti-fog properties, up to total failure.

With laminates, these properties actually appear to be enhanced through chemical interaction of the anti-fog agent with adhesives and quantitatively more polar material, which the anti-fog agent prefers to absorb. Because the migration of this material takes place without limits, a functioning guarantee of this type of anti-fog layer is not given over a long period.

Especially problematic are polypropylene multi-layer films, which are popular because of their relatively good temperature resistance etc., yet they interact poorly with anti-fog agent.

Polypropylene films with anti-fog properties are already well-known. JP 58079044 A and also JP 02187441A describe polypropylene layers for multi-layer films with special anti-fog agents that are less prone to migration.

JP09248880A explains a polypropylene laminate in which a layer that contains anti-fog agent is extruded together with a polypropylene layer.

The prior art of polypropylene anti-fog film is unfavourable with regards to the printability and/or transparency or hot-tack properties of the film. Furthermore, the prior art films can be improved with regard to their anti-fog properties, particularly in regard to the long-term stability of these properties.

The purpose of the invention at hand is to provide a sealable multi-layer film with good and enduring anti-fog properties even when stored on a roll for long periods of time.

The purpose is achieved through the features of patent claim 1. Advantageous embodiments of the invention are the result of the dependent claims.

Surprisingly, it has been shown that the inventive multi-layer film exhibits very good optical characteristics, that is, high transparency and good lustre, as well as sealing properties, especially a good hot-tack.

In order to prevent migration of the anti-fog agent to polar groups within the film/composite and force the anti-fog agent substance onto the surface of the sealing layer, a polypropylene barrier for the anti-fog agent substance is placed according to the present invention between the sealing layer and the polar layer behind it.

This anti-fog agent barrier layer can be e.g. polypropylene. Due to its high crystallinity, it inhibits the migration to the polar components of the multi-layer film or the composite. Polypropylene-homo is mainly used, but polypropylene-block or polypropylene-random are also acceptable.

It is especially preferred that even the cover layer of the film composite exhibits barrier properties against the anti-fog agent, in order to inhibit the migration of the anti-fog agent out of the sealing layer on the film roll onto into the cover layer and guarantee the function of the barrier layer film even on the roll.

According to the invention, anti-fog properties (Cold-fog) of level 5 (very good) can be ensured for at least 6 months, in which the experience shows that the anti-fog agent effect was retained even beyond the time period.

Sealing layers in terms of the invention are the layers that face that product and are heat-sealable. Heat-sealing shall be understood to mean a seal created by continuously heated/impulse-heated/ultrasound tools, in which the sealing jaws press together the composite to be sealed and at least the inner layer of the composite is fused with another sealing layer made of the same composite (e.g. sealed pouches) or with the polymer-surface of another object, such as a bowl-like container.

Cover layers are those layers which form the external layers. They can be chosen according to properties such as: mechanical stability, strength, lustre. In the present case, they preferably have barrier properties against the anti-fog agent.

Preferred cover layers are polypropylene, polyester, and polyamide.

Interlayers are the layers that exist between the cover layer and the sealing layer. In general these can involve adhesive (adhesion agent, laminating adhesive), moisture barrier layers, anti-fog agent barrier layers, gas barrier layers, as are familiar to experts skilled in the art.

Typical gas barrier layers are known from e.g. DE 10 2004 062 204 A1. The gas barrier layer prevents the admission and escape of gasses. It is especially important to prevent oxygen from reaching the foodstuffs, as it would foster decomposition and mould formation, and that any protective gasses such as nitrogen or carbon dioxide incorporated into the packaging do not escape. Such gas barrier layers comprise essentially e.g., polyamide, lacquered cellophane, ethylene vinyl alcohol polymers (EVOH), or other vinyl alcohol polymers (PVOH), or they are built from multiple layers of these materials. Polyamide and/or EVOH by itself is permeable to water vapour and exhibits poor sealing properties, i.e., it is not suited for fusing, as is necessary for foodstuffs and animal feed as a rule. In order to prevent foodstuffs from drying out, the packaging film is normally provided with an additional layer as a water barrier. Suitable materials for the gas barrier layer are polyamide, lacquered cellophane, ethylene vinyl alcohol polymers (EVOH), or other vinyl alcohol polymers (PVOH). The barrier layer can generally be made essentially of one of these materials. It is also possible to construct the barrier layer itself of multiple layers, e.g., from a layer of EVOH in which one or both sides include a polyamide layer. This multi-layered barrier layer can be manufactured through co-extrusion or it can be laminated and/or lacquered.

Water vapour barrier layer films are familiar to the experts skilled in the art. Especially suitable are polyisobutylene and/or butyl rubber polymers, styrene polymers such as SEBS or also phyllosilicate filled polyamide. The additional layer which serves as the water vapour barrier can exhibit good sealing properties, so that, first of all, this layer provides a sealable packaging film and, secondly, this packaging film is additionally water-vapour-tight in the generally desired ways.

According to the invention, an anti-fog film is provided—as for the packaging of foodstuffs and animal feed or alternatively as an anti-fog layer in the composite films such as plastic glass panes, which, if necessary, holds protective gasses and/or water in the packaging and protects the foodstuffs from oxygen. This film has a barrier layer, which has a high barrier performance against anti-fog agent. This barrier layer thus meets the criteria of keeping anti-fog agent away from the overlying film and preventing the loss of anti-fog agent, optionally retaining the protective gasses that were incorporated into the packaging.

To make a film such as this sealable, such that the film is also suitable for use as packaging film, the film also exhibits a superficial sealing layer with anti-fog agent, which possesses good sealing properties. The sealing layer compromises the functional properties of the barrier layer. Because the barriers to gas and moisture are achieved by at least one gas/moisture barrier layer, the sealing layer can also be gas-permeable. “Gas barrier” and “gas-permeable”, respectively, shall be understood to mean a barrier and permeability of substances that are gaseous at normal ambient temperatures, especially oxygen, nitrogen, and carbon dioxide.

The anti-fog agent barrier layer of the film generally comprises at least 80% by weight or preferably 90 to 100% by weight, in particular 98 to <100% by weight respectively, relative to the anti-fog agent barrier layer, of a propylene polymer described below. No anti-fog additive is added to this anti-fog agent barrier layer.

It was found that a barrier layer of polypropylene contributes favourably to the desired profile of properties of the film. The anti-fog additive migrates out of the sealing layer only as far as the barrier layer, for this anti-fog agent barrier layer acts as an effective migration barrier against the anti-fog additive.

Consequently, only the sealing layer acts as an anti-fog agent reservoir, in which a loss of an anti-fog agent through immigration into other film layers can be avoided because of the barrier.

The propylene polymer of the anti-fog agent barrier layer comprises in particular preferably at least >98 to 100% by weight propylene. The corresponding co-monomer content of 0 to at most 2% by weight based on the propylene, if present, is comprised generally of ethylene. Isotactic propylene homopolymer is preferred.

The propylene homopolymer generally has a melting point of 140° to 170° Celsius.

In general, the anti-fog agent barrier layer can also exhibit common stabilisers and neutralisation agents, as are known to experts skilled in the art.

Surprisingly, due to the specific composition of the film with high additive levels only in the sealing layer, it is possible to realise various desired performance properties of the films side-by-side. The film shows the desired anti-fog properties; notably, these are surprisingly consistent and have long-term stability. The sealing layer forms the anti-fog reservoir from which the anti-fog agent additive can migrate for some time, so that even several days after it is used to package moist food, no droplet formation appears on the film. At the same time, the adverse effects of the anti-fog additive on transparency and cohesion surprisingly do not occur. In spite of good anti-fog properties, the film demonstrates good adhesion of the layers to each other and very good transparency. The adhesion promoter layer 12 is not saturated by the anti-fog agent barrier layer and can therefore produce adhesion. This allows appropriate dosage in the sealing layer 10.

The anti-fog agent barrier layer creates an effective barrier against a migration of the anti-fog additive to the surface of the cover layer. Consequently, a film is provided which exhibits an especially beneficial combination of properties. The film has anti-fog properties that are stable and consistent over especially long periods and still has a very good transparency, good hot-tack properties and is also printable, if desired.

In addition to food packaging, the inventive anti-fog film is also suitable as an anti-fog film or anti-fog layer for windscreens, sports goggles, helmet visors or plastic glasses or mineral glass panes as well as greenhouse films of any sort.

The invention is described in detail below, with examples as well as accompanying illustrations, though the invention is not limited in any way to these examples. The illustrations show:

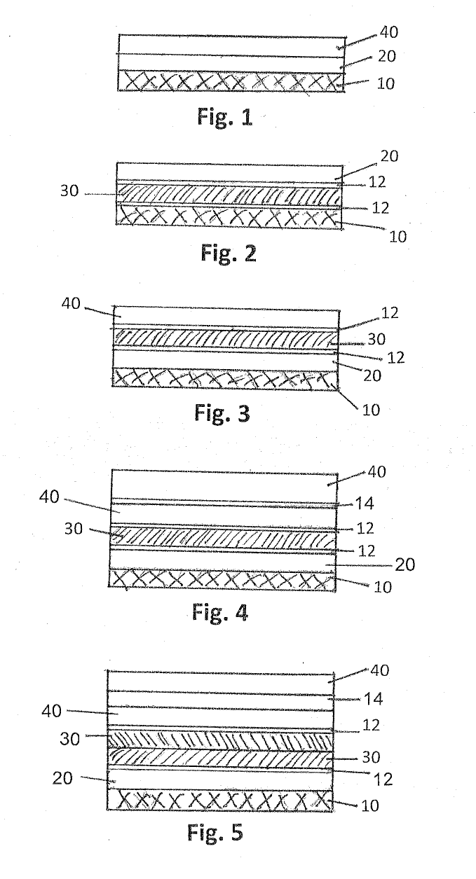

FIG. 1: a 3-layer film composite as a film subcombination for multi-layer film

FIG. 2: a 5-layer film composite with oxygen barrier layer

FIG. 3: a 6-layer film composite

FIG. 4: a multi-layer film with the composite from FIG. 3

FIG. 5: another multi-layer film with the composite from FIG. 3

FIG. 1 is a simple co-extruded film composite without gas barrier, which is complemented by additional films in the finished composite, depicted schematically. An anti-fog sealing layer 10 made of PE with an anti-fog agent is covered by an anti-fog agent barrier layer 20 made of polypropylene, onto which a polyethylene layer 40 is extruded as a cover layer. This film composite is suited for packaging of goods, in which gas barrier properties are not required. If necessary, additional cover layers can be applied to this composite in order to improve the resistance of the film to temperature and/or increase mechanical stability.

Films of this type are especially suited for greenhouse films.

FIG. 2 shows an anti-fog multi-layer film with gas barrier 30 and improved shelflife on the roll. The sealing layer 10 equipped with anti-fog agent—here essentially made of PE—is overlaid with an EVOH gas barrier layer 30, which is bound over an adhesion promoter 12. On the outside of the gas barrier layer, a polypropylene cover layer 40 is applied by means of an additional adhesion promoter 12 to protect the composite from inward diffusion of the anti-fog agent on the roll as well as the discharge of the anti-fog agent from the cover layer 40. The film exhibits good stability and a good transparency in use.

In FIG. 3, a six-layer anti-fog multi-layer film is shown, in which a polypropylene anti-fog agent barrier layer 20 is extruded directly onto the anti-fog agent sealing layer 10, as in FIG. 1. This polypropylene layer 20 prohibits the anti-fog agent from migrating into the film and forces it into the sealing layer 10. On top of the polypropylene layer, EVOH is bound as a gas barrier layer 30 by means of an adhesion promoter. Because the polypropylene layer 20 in this form protects the gas barrier layer 30, a migration of the anti-fog agent into the same is not possible. The migration of anti-fog agent into EVOH is inherently fostered through the polar character of the EVOH, but it nevertheless leads to undesired changes in the EVOH properties and the properties of the adhesion promoter 12 and, in worst cases, to delamination.

FIG. 4 shows a complete film composite with the film combination from FIG. 3. On the cover layer 40, the hard layer is applied by means of a laminating adhesive 14 to induce the appropriate lustre and scratch resistance in the film. These can be e.g. oriented/stretched polypropylene, oriented/stretched polyamide, or polyester.

FIG. 5 shows an additional complete film composite with improved barrier properties against moisture and gas through the use of a polypropylene barrier layer made of polyamide together with EVOH. Both materials complement each other beautifully with regards to their barrier function to create a multi-layer film with exceptional barrier properties. Otherwise, the construction of the film in FIG. 5 is similar to that of FIG. 2, except that a double barrier layer is attached to the anti-fog agent sealing layer. The cover layer is laminated, as is also possible with the combination of FIG. 2.

It is self-evident that, if necessary in the common processing of recycled film material, negligible amounts of anti-fog additive can possibly be contained in the remaining layers of the film. These quantities must be kept so small that no damaging amounts migrate to the second outer surface of the film.

The total thickness of the inventive polypropylene film can vary within other boundaries and be determined by the intended application. It amounts to preferably 0.004 to 0.120 mm, in particular 0.005 to 0.080 mm, in which the anti-fog agent barrier layer constitutes approximately 10 to 50% of the total film thickness.

The invention furthermore concerns a procedure for manufacturing the inventive polypropylene film according to the conventional co-extrusion procedure.

In the process, as is the case with co-extrusion processing, the polymers or the polymer blends of the individual layers are each packed and liquefied into extruders, whereby any necessary additives can be either already contained in the polymers or the polymer blends or can be incorporated as a master batch. At the same time, the melts are then pressed through flat nozzles (broad-slit nozzles) and create films that merge while still warm and cohere upon cooling and solidifying.

Suitable materials for the gas barrier layer are polyamide, lacquered cellophane, ethylene vinyl alcohol polymers (EVOH), or other vinyl alcohol polymers (PVOH). The barrier layer can generally be made of one of these materials. It is also possible to construct the barrier layer itself of multiple layers, e.g., from a layer of EVOH which is covered on one or both sides include a polyamide layer. This multi-layered barrier layer can be manufactured through co-extrusion or it can be laminated and/or lacquered.

If necessary, it is also possible to stretch the film obtained in this way, which leads to an alignment of the molecular chains and shrinkage properties for the film. Temperatures at which longitudinal and lateral stretching are realised can vary across a relatively broad range and are determined by the desired properties of the film.

It is also possible to design the cover layer composite so that one of the layers is at least partially printed. The printing can be protected through superimposition of another cover layer.

Surprisingly, the sole formulation of the inner sealing layer 10 with anti-fog additives is sufficient to achieve consistent anti-fog properties in the film. The polypropylene barrier layer 20 functions as an additive barrier layer and prohibits loss of the anti-fog agent through migration inside of the film. Thus a consistently excellent anti-fog property is ensured.

It was found that, due to the inventive composition of the film, the anti-fog additive effectively did not increase the opacity of the film. This is essential for a transparent packaging film, which is expected to emphasize a visually attractive packaged good.

Classic thicknesses of the single films in an inventive composite can be as follows:

Sealing layer: 0.004 mm-0.1 mm, in particular 0.008 mm 0.05 mm

Barrier layer: 0.004 mm 0.1 mm, in particular 0.008 mm 0.1 mm

EVOH layer: 0.001 mm 0.1 mm, in particular 0.002 mm 0.01 mm

Adhesion promoter: 0.001 mm 0.01 mm, in particular 0.002 mm 0.008 mm

Polypropylene layer: 0.008 mm 0.1 mm, in particular 0.01 mm 0.04 mm

Although the present invention has been described with reference to preferred embodiments, it is in no way limited to the same, but rather experts skilled in the art will recognize that changes may be made in form and detail without departing from the spirit and scope of the invention.

### LIST OF REFERENCES

10 Sealing layer with anti-fog agent
12 Adhesion promoter
14 Laminating adhesive
20 Anti-fog barrier layer
30 Oxygen barrier layer
40 Cover layer/hard layer/cover layer

1-12. (canceled)

13. A clear, transparent anti-fog multi-layer film with improved resistance to delamination and desirable functional endurance comprising:
at least one sealing layer that contains an anti-fog additive made of a polyolefin/anti-fog agent mixture,
at least one anti-fog agent barrier layer containing 80 to 100% polypropylene, and
at least one cover layer.

14. The anti-fog multi-layer film of claim 13, further comprising at least one additional functional selected from the group consisting of a gas barrier layer, a UV-protection layer, an adhesion promoter layer, an adhesive layer, a cover layer, a hard layer, a moisture barrier layer.

15. The anti-fog multi-layer film of claim 13, wherein the anti-fog agent barrier layer has at least 90% by weight of a propylene polymer.

16. The anti-fog multi-layer film of claim 13, wherein the anti-fog additive is at least one additive selected from the group consisting of an ester of a fatty acid, an aliphatic alcohol, an ethoxylated aromatic alcohol, a mono- or multi-esterified sorbitol ester, a mono- or multi-esterified glycerol ester, an ethoxylated sorbitan ester and an ethoxylated amine.

17. The anti-fog multi-layer film claim 13, wherein the cover layer has at least 90% of a propylene polymer.

18. The anti-fog multi-layer film of claim 13, further comprising a hard layer applied over the cover layer.

19. The anti-fog multi-layer film of claim 13, wherein at least a partial composite of the multi-layer film is co-extruded.

20. The anti-foe multi-layer film of claim 13, wherein the multi-layer film is sealable through the use of continuous-heating, impulse-heating, ultrasound tools.

21. An article comprising the anti-fog film multi-layer film of claim 13 in combination with a foodstuff, packaging, a pane, an inspection window, eyeglasses, or a greenhouse.

22. The anti-fog multi-layer film of claim 14, wherein the anti-fog additive is at least one additive selected from the group consisting of an ester of a fatty acid, an aliphatic alcohol, an ethoxylated aromatic alcohol, a mono-esterified sorbitol ester, a multi-esterified sorbitol ester, a mono-esterified glycerol ester, a multi-esterified glycerol ester, an ethoxylated sorbitan ester and an ethoxylated amine.

23. The anti-fog multi-layer film of claim 15, wherein the anti-fog additive is at least on additive selected from the group consisting of an ester of a fatty acid, an aliphatic alcohol, an ethoxylated aromatic alcohol, a mono-esterified sorbitol ester, a multi-esterified sorbitol ester, a mono-esterified glycerol ester, a multi-esterified glycerol ester, an ethoxylated sorbitan ester and an ethoxylated amine.

24. The anti-fog multi-layer film of claim 20, wherein the tools comprise sealing jaws.
